(19) United States
(12) Patent Application Publication
(10) Pub. No.: US 2020/0213216 A1
(43) Pub. Date: Jul. 2, 2020

(54) METHOD FOR DYNAMIC ROUTING IN INTERCONNECTED NETWORKS OF CONNECTED OBJECTS

(71) Applicant: BULL SAS, Les Clayes-sous-Bois (FR)

(72) Inventors: Bruno DEMEILLIEZ, Saint Laurent du Pont (FR); Gilles MENIGOT, Froges (FR); Wajih CHAABANE, Chambery (FR)

(21) Appl. No.: 16/731,199

(22) Filed: Dec. 31, 2019

(30) Foreign Application Priority Data
Dec. 31, 2018 (EP) 18306905.3
May 6, 2019 (FR) 1904718

(51) Int. Cl. H04L 12/715; H04L 12/66; H04L 29/08

(52) U.S. Cl. CPC H04L 45/04; H04L 12/66; H04L 67/1072; H04L 67/1091; H04L 67/12

(57) ABSTRACT

A dynamic routing method in interconnected networks of connected objects is hereby proposed. The purpose of the method is the generation and maintenance, by a connection gateway of a network of connected objects, of a routing list used by said connection gateway for its routing functions. Additionally, the method enables a connection gateway to select the most appropriate transmission path for transmitting a message from a source connected object to a receiving connected object within a network infrastructure formed by at least two networks of connected objects and a data transport network interconnecting them.

### CROSS-REFERENCE TO RELATED APPLICATIONS

This application claims the benefit of European Patent Application No. 18306905.3 filed Dec. 31, 2018 and French Patent Application No. 1904718 filed May 6, 2019, the disclosures of which are herein incorporated by reference in its entirety.

This invention relates to the field of connected objects and, in particular, the exchange of data in a network infrastructure comprising connected objects. It relates in particular to a method of dynamic routing in interconnected networks of connected objects which each comprise several connection gateways which respectively use different communication interfaces.

### PRIOR ART

The Internet of Things (loT) refers to all objects connected to the Internet and it is a field of Information and Communications Technologies (ICT) that is rapidly growing. In fact, the IoT has applications in more and more varied fields, such as, for example, the smart city, self-driving cars, automated houses or even smart home management

The electronic devices involved in these applications are called connected objects, in the sense that they interact through local sub-networks that can be connected to a high-speed core network such as the Internet. Several local sub-networks can be integrated into a single network of connected objects. Such a network of connected objects, also called a local area network hereinafter, comprises several connection gateways, specific to each subnetwork, to which one or more connected objects are respectively connected. Each connection gateway is responsible for routing messages which pass, on the one hand, between the various connected objects of the local network and, on the other hand, between the connected objects of the local network and a data transport network (such as for example Internet).

Additionally, several local networks can be interconnected through a data transport network. In this case, the connection gateways in the interconnected local networks are connected to connection gateways in the data transport network. Messages can thus go through among connected objects of separate networks of connected objects. In other words, a message can be transmitted from a source connected object in a given network of connected objects through several connection gateways, of which at least one is a connection gateway in a data transport network, to a receiving connected object in another network of connected objects.

In such a configuration, the connection gateway to which the source connected object is connected must be able to ensure the routing of the message to be transmitted throughout the network infrastructure formed by the network of connected objects to which the source connected object belongs, the data transport network, and the network of connected objects to which the receiving connected object belongs.

Thus, in order to perform this routing optimally, a connection gateway must be able to select the most appropriate transmission path for a message from among several potential transmission paths. For example, the connection gateway must be able to select the most stable or fastest transmission path between one connected object and another. Furthermore, this capability must be dynamic as the network infrastructure within which the message passes may change over time. For example, temporary connection gateways can be added or removed in each network involved.

Finally, in addition to the fact that each subnetwork may rely on its own technology for Internet connectivity (for example, with an ADSL Box, a 4G BOX, a WiMax connection, a Satellite connection, a mobile phone), each connection gateway potentially uses one or more different communication interfaces. Typically, the connection gateways in a network of connected objects can use Ethernet interfaces, WIFI interfaces, Bluetooth interfaces, RF433 interfaces or IrDA interfaces. Thus, the interconnection among different connection gateways assumes that each connection gateway is capable of performing its routing functions regardless of the different communication interfaces used by the different connection gateways involved.

European patent application EP3425861 discloses a method for routing data among different devices forming nodes of a network of connected objects. Such a method aims to provide an efficient solution for routing optimization in order to minimize the data collection latency without using complex network planning tools. This patent application discloses, in particular, the generation of graphs for representing the quality of the communication link for each level in the network, and shows a score for each node of each network level, in order to generate routing lists. A connection gateway designates one concentrator node per level, which corresponds to the node with the highest score. Other characteristics can be calculated or taken into account such as, for example, the shortest path. However, such a method cannot simply generate a mesh among connected objects, particularly in an environment using different communication protocols.

### Technical Problem

The purpose of the invention is to remedy the above-mentioned problems from the background art. In particular, the purpose of this invention is to provide a method for generating and maintaining a routing list among connected objects used by a connection gateway in order to operate its data routing functions. In particular, the routing list enables the selection, in real-time, of the most appropriate transmission path to transmit a message from a source connected object to a receiving connected object. Furthermore, the method applies to a connection gateway included in a network infrastructure formed by at least two networks of connected objects and a data transport network interconnecting them. Finally, the method also applies to a network infrastructure that comprises a plurality of connection gateways that may potentially use different communication interfaces.

### BRIEF DESCRIPTION OF THE INVENTION

For this purpose, a first aspect of this invention provides a method for dynamic routing in interconnected networks of connected objects, each network of connected objects comprising at least one connection gateway to at least one data transport network, said networks of connected objects being interconnected through said data transport network, said method comprising the following steps, performed by a first connection gateway of a local network of connected objects:

transmitting, by the first connection gateway to a second connection gateway, a list of unique connected object identifiers with which the local connected objects are likely to communicate,

receiving, by the first connection gateway, a first routing message from the second connection gateway, said first routing message comprising a list of identifiers of connected objects with which the local objects are likely to communicate and for which the second connection gateway has a transmission path,

generating a routing list comprising identification information respectively associated with local connected objects connected to the first connection gateway and identification and accessibility information respectively associated with at least one second connection gateway of the local network of connected objects and/or of a remote network of connected objects accessible by said first connection gateway;

and, upon receipt by the first connection gateway of a message to be transmitted from a source connected object to a receiving connected object:

selecting a transmission path of the message to be transmitted based on the identification information and/or the identification and accessibility information included in the routing list.

Such a method makes it possible to obtain, from a plurality of connection gateways, either local or remote, which potentially use different communication interfaces, a list of connected objects, with which the local objects are likely to communicate, accessible through each of these gateways. Thus, the first connection gateway can generate and maintain a routing list between connected objects which will be used to operate data routing functions.

This method is particularly useful in an environment comprising several connection gateways between connected objects with different communication protocols and for which the availability or connectivity characteristics may change over time. Thus, using such a method, it is possible to have objects communicate while using different communication protocols, some of which are not directly available for the connected object. For example, a sensor (temperature, barometer) which only communicates under the RTL433 protocol with a computer, will be able to communicate with a telephone which is linked to a wifi network, going through a gateway such as a wifi box which links the computer and the telephone. In particular, the present invention proposes a mechanism allowing connected objects to use the different communication technologies (wifi, wired network, Bluetooth, IR) of the other connected objects to which they are directly connected (latency=0) to dialog with the connected objects, connected to these first connected objects and so on. Therefore, this allows to link the connected objects therebetween by incorporating different communications technologies.

Additionally, in order to ensure the transmission of a message between a connected object and a remote device (such as another connected object) within a network with different communications technologies, it is desirable to have available a dynamic routing mechanism which can provide, to the connected object wishing to send a message, the most effective path to the receiving device, and to do so through diverse communication protocols.

Thus, one of the advantages of the invention is to allow objects using different protocols to communicate, when they would not normally be able to dialog with each other. The mechanism allows to uniquely identify the different connected objects in the sub-network(s) and to be able to route messages despite the fact that the connected objects use different communication protocols. Indeed, the method according to this invention makes it possible to obtain, from the remote gateways, the list of identifiers accessible through this gateway and this is achieved through a transmission of unique identifiers by a second connection gateway corresponding to the unique identifiers of the connected objects with which the local objects are likely to communicate and which the second gateway is able to reach.

According to other optional characteristics of the method:
the first gateway sends a concatenated list of the identifiers of the connected objects with which the local objects are likely to communicate, and the second gateway, either remote or local, returns a subset containing the identifiers for which it has a routing. This makes it possible to limit the size of the routing list since it is limited to the identifiers for which it has a routing, on the one hand, and only those with which the local objects are likely to communicate, on the other hand.
it comprises a step of propagating the list of unique identifiers of connected objects with which the local connected objects are likely to communicate from gateway to gateway. Preferably, the propagated list includes an indicator of the number of hops still allowed, which is reduced at each transmission. Thus, a limit is set on the number of gateway-to-gateway hops that the method according to this invention can support. Thus, only useful identifiers are transmitted, i.e. those that are not too far away.
The first routing message coming from the second connection gateway, comprises a list of the identifiers of connected objects directly connected to the second connection gateway and comprises a step of reception by the first connection gateway of a second routing message coming from the second connection gateway, said second routing message comprising a list of the identifiers of connected objects with which the local objects are likely to communicate and for which it has a transmission path that implements another remote connection gateway.
The unique identifiers of connected objects are parameterized so as to be able to uniquely identify, in the subnetwork or subnetworks, the connected objects linked through different communication protocols. Thus, it is possible to communicate with connected objects that do not necessarily have the same type of communication mechanism (Ethernet, WIFI interfaces, Bluetooth interfaces, RF433 interfaces or IrDA interfaces). In particular, the first connection gateway uses a different communication protocol than the second gateway.
In particular, the routing message includes a list of unique universal identifiers, UUIDs, including the UUIDs of local connected objects associated with:
   the UUIDs of the remote connected objects directly connected to the second connection gateway;
   the UUIDs of remote connected objects that are connected to the second connection gateway through other connection gateways; or
   the UUIDs of remote connected objects with which the connected objects directly connected with the second connection gateway are able to establish a communication link.
Thus, these lists contain identifiers present in the lists of local connected objects and their presence associated with the UUIDs of remote connected objects means that a path has been found to communicate with these remote connected objects. Preferably, the routing list also contains data on the transmission path to connect one of the local connected objects to one of the remote connected objects.
The method further comprises deleting, based on a specific performance criterion, identification information and/or redundant identification and accessibility information from the routing list so as to keep only a single copy of each of said information in the routing list;

In one embodiment, the method further comprises sending, by the first connection gateway, the message to be transmitted, to the receiving connected object, through the selected transmission path.

In one embodiment, the identification information associated with a specific connected object comprises one or more of the following information:

the type of communication interface supported by the first connection gateway for the connection with said connected object;

the name of the communication interface supported by the first connection gateway for the connection with said connected object;

the address of said connected object on the communication interface supported by the first connection gateway for the connection with said connected object;

the unique, universal identifier, UUID, of said connected object; and,

a list of unique universal identifiers of other connected objects with which said connected object is capable of establishing a communication link.

In one embodiment, the identification and accessibility information elements associated with a second specific connection gateway of the local network of connected objects or an accessible remote network of connected objects comprises one or more of the following information:

the type of communication interface supported by the first connection gateway for the connection with said second connection gateway;

the name of the communication interface supported by the first connection gateway for the connection with said second connection gateway;

the address of said connection gateway on the communication interface supported by the first connection gateway for the connection with said second connection gateway;

In one embodiment, the list of unique universal identifiers is obtained by the concatenation of all the unique universal identifiers included in said list.

In one embodiment, the connection gateways, each have their respective communication interfaces, and the communication interfaces used by the connection gateways include Ethernet interfaces, WIFI interfaces, Bluetooth interfaces, RF433 interfaces or IrDA interfaces.

In one embodiment, the specific performance criterion is based on one or more of the following parameters:

the latency associated with a data transmission from the first connection gateway to a connected object or to another connection gateway; and,

the distance separating the first connection gateway from a connected object or another connection gateway.

In one embodiment, the identification information associated with a connected object and the identification and accessibility information associated with a connection gateway further comprise a value that represents the latency associated with a data transmission from the first connection gateway to said connected object or said connection gateway, respectively.

In one embodiment, the identification information associated with a connected object and the identification and accessibility information associated with a connection gateway further comprise a value that represents the distance separating the first connection gateway from said connected object or said connection gateway, respectively.

In one embodiment, the routing list is stored in a memory of the first connection gateway and updated upon receipt, by the first connection gateway, of a message comprising identification information elements or identification and accessibility information from a connected object or another connection gateway, respectively.

According to a second aspect, this invention relates to a connection gateway of a network of connected objects, said network of connected objects being interconnected with another network of connected objects through at least one data transport network and comprising connection gateways, each having their respective communication interfaces, said connection gateway being characterized in that it comprises:

a communication module configured to transmit to a second connection gateway a list of unique identifiers of connected objects with which the local connected objects are likely to communicate, and to receive a first routing message from the second connection gateway, said routing message comprising a list of the identifiers of connected objects with which the local connected objects are likely to communicate and for which it has a transmission path; and

a generation module configured to allow the connection gateway to generate a routing list that comprises identification information associated with connected objects and identification and accessibility information associated with connection gateways;

a selection module configured to select a transmission path when the connection gateway receives a message to be transmitted from a source connected object to a receiving connected object of the network of connected objects, said selection being carried out based on the routing list.

The connection gateway according to this invention may further comprise a deletion module configured to delete identification information and/or redundant identification and accessibility information from the routing list so as to keep only a single copy of each of said information in the routing list.

According to a third aspect, this invention relates to a data communication system comprising at least two networks of connected objects interconnected through a data transport network, said networks of connected objects comprising a plurality of connection gateways, each having their respective communication interfaces; in the system according to this invention, each connection gateway is configured to transmit to a first connection gateway routing messages including a list of connected object identifiers with which the local connected objects of the first connection gateway are likely to communicate and for which it has a transmission path, to generate a routing list that includes identification information associated with connected objects and identification and accessibility information associated with connection gateways, and to select, based on the routing list, a transmission path when the connection gateway receives a message to be transmitted from a source connected object to a receiving connected object in the network of connected objects.

Other features and advantages of this invention will become evident in the following description, given as an illustrative and non-limiting example, referring to the figures in the attached drawings, wherein:

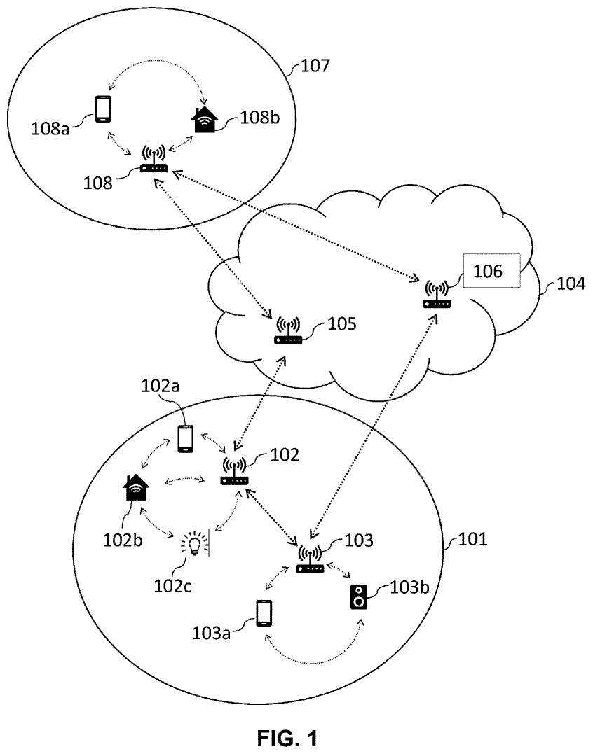

FIG. 1 is a schematic representation of an embodiment of a network of connected objects within which the method according to this invention can be implemented; and,

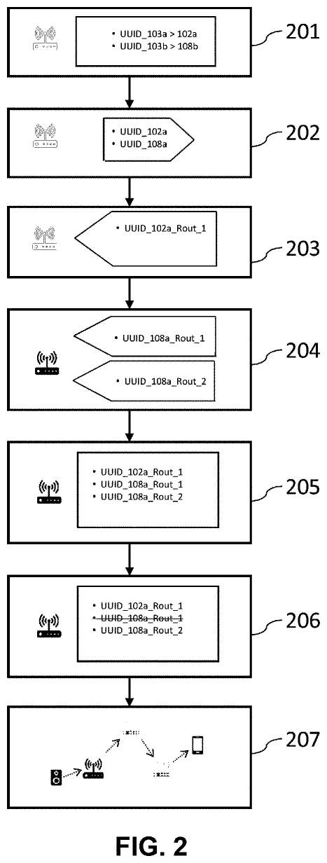

FIG. 2 is a step diagram of an embodiment of the method according to this invention.

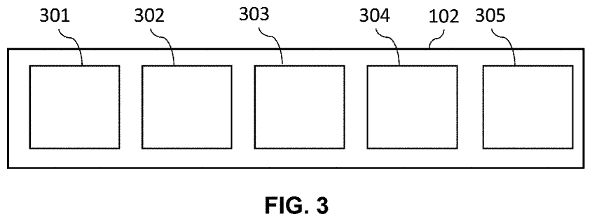

FIG. 3 is a functional diagram of an embodiment of a connection gateway according to this invention.

Aspects of this invention are described referring to flow diagrams and/or functional diagrams of methods, devices (systems) according to embodiments of this invention.

In the figures, the flow diagrams and the functional diagrams show the architecture, functionality and operation of possible implementations of systems and methods according to various embodiments of this invention. In this respect, each block in the flow diagrams or block diagrams may represent a system, device, module or code, which comprises one or more executable instructions to implement the specified logical function(s). In some implementations, the functions associated with the blocks may appear in a different order than that shown in the figures. For example, two blocks shown in succession may, in fact, be executed substantially simultaneously, or the blocks may sometimes be executed in the reverse order, depending on the functionality involved. Each block in the block diagrams and/or flow diagrams, and combinations of blocks in the block diagrams and/or flow diagrams, may be implemented by special hardware systems that perform the specified functions or execute or perform combinations of special hardware and computer instructions.

### DESCRIPTION OF THE INVENTION

In the next part of the disclosure, a connected object is a electronic object connected, by a wired or wireless connection, to a data transport network, such that the connected object can share data with another connected object, a server, a fixed or movable computer, an electronic tablet, a smart phone or any other connected device of a given network. In a known manner, such connected objects can be, for example, home automation devices, smart lighting devices, connected speakers or even smart phones.

Gateway or connection gateway, within the meaning of the invention, means equipment ensuring the connection between equipment belonging to different local networks or sub-networks, for example, ensuring the connection between equipment of a network of connected objects (local IP addresses) and Internet services (public IP addresses). Thereby, such a gateway has two types of IP addresses. Its public IP address, allocated by the FAI, makes it possible for it to exchange data with the Internet network. Its local IP address makes it possible for it to exchange data with the equipment in its local sub-network. Generally, it is specific and allocated by default by the ISP.

Within the meaning of the invention, sub-network or local network means, for example, local networks, each served by at least one connection gateway to another network such as the Internet and to which the connected objects are connected.

The term directly connected means a connection of a connected object to the connection gateway that does not go through any intermediate entity whatsoever.

Within the meaning of this invention, message or message to be transmitted, means a message sent between connected objects through at least one gateway or between connected object and gateway, or even between gateways, and comprising data that may include information related to their status and to that of their environment. The format of this data can, for example, correspond to files, media streams (video, audio) or coded values.

Within the meaning of the invention, transmission path means the set of the connection gateways through which a message issued by a source connected object must go through, in succession, in order to reach the receiving connected object.

Within the meaning of the invention, list means a plurality of data that allow to indicate specific information, in particular in connection with identification and/or accessibility information.

To process, calculate, determine, display, extract, compare or more broadly, an executable operation, within the meaning of this invention, means an action executed by a device or processor unless otherwise indicated. In this respect, operations relate to actions and/or processes in a data processing system, for example a computer system or electronic computing device, which manipulates and transforms data represented as physical (electronic) quantities in the memories of the computer system or other devices for storing, transmitting or displaying information. These operations can be based on applications or software programs.

The terms or expressions application, software program, program code and executable code mean any expression, code or notation in a set of instructions designed to produce data processing to perform a particular function directly or indirectly (e.g., after a conversion operation to another code). Examples of program code can include, not limited to, a sub-program, a function, an executable application, a source code, an object code, a library and/or any other sequence of instructions designed for execution on a computer system.

Within the meaning of this invention, processor means at least one physical circuit configured to execute operations according to the instructions contained in a code. The physical circuit can be an integrated circuit. Examples of a processor include, but are not limited to, a central processing unit, a graphic processor, an application-specific integrated circuit (ASIC) and a programmable logic circuit. A single processor, or several other units, can be used to embody the invention.

Referring to the diagram in FIG. 1, an embodiment of interconnected networks of connected objects wherein the method can be implemented will be first described.

In the example shown in FIG. 1, networks of connected objects 101 and 107 each allow the different connected objects they comprise to be connected to the data transport network 104, for example to the Internet, through their connection gateways 102, 103 and 108, respectively. In particular, connection gateways 102, 103 and 108 are adapted to establish a connection with a connection gateway in the data transport network 104. This connection may, for example, use a wired technology, such as the Ethernet technology, or a wireless technology, such as the 4G technology or the WiMax technology. In the example shown, connection gateways 102 and 108 establish a communication link with connection gateway 105 while connection gateway 103 establishes a communication link with connection gateway 106 of the data transport network 104.

Each of the three connection gateways 102, 103 and 108 is directly connected to a plurality of connected objects of the network of connected objects to which it belongs. In particular, connection gateway 102 is directly connected to connected objects 102a, 102b and 102c, connection gateway 103 is directly connected to connected objects 103a and 103b, and connection gateway 108 is directly connected to connected objects 108a and 108b.

Furthermore, the person skilled in the art will understand that the different connected objects which are directly connected to a connection gateway are, in fact, also connected therebetween via said connection gateway. Finally, each connected object is capable of establishing other connections, i.e. other communication links, with other connected objects, which are not directly connected to the same connection gateway. In other words, a connected object can then be connected to a connection gateway without being directly connected to said gateway. Indeed, in this case, it is connected through the connection gateway to which it is directly connected, which in turn is connected, either directly or not, to said connection gateway.

Generally, in networks of connected objects, each connection gateway uses one or more communications interfaces belonging to it in order to communicate with the connected objects that are directly connected to it. For example, it can be an Ethernet interface, a WIFI interface, a Bluetooth interface, an RF433 interface or an IrDA interface. The person skilled in the art will understand that the embodiments of a connection gateway in which this invention can be embodied are not limited either by the number or by the type or nature of the connection interfaces that are supported. In any case, an advantage of the method according to the embodiments lies in particular in the fact that said method is applied in interconnected networks of connected objects which may comprise several connection gateways which use different communication interfaces.

In summary, connection gateways 102, 103 and 108 of networks of connected objects 101 and 107 ensure the routing of data, and in particular of messages, between the different connected objects of the global network infrastructure formed by the two networks of connected objects 101 and 107 and the data transport network 104. The two networks of connected objects 101 and 107 are thus interconnected through the data transport network 104. Additionally, these connection gateways are also adapted to ensure the routing of messages, through them, from a source connected object connected to them, either directly or indirectly, to a receiving connected object which is connected to another connection gateway of the network infrastructure. Thus, in the example shown in FIG. 1, connection gateway 102 ensures the routing of messages exchanged with the data transport network 104 and, where applicable, with a connected object connected to connection gateway 103 or to connection gateway 108.

The person skilled in the art will understand that the example described referring to FIG. 1 is not exhaustive. In particular, implementations of the method may apply to a network infrastructure consisting of more than two networks of connected objects and more than one data transport network. Additionally, each connection gateway may be connected, either directly or indirectly, with one or more connected objects without limit on the number of connection gateways through which messages may be transmitted to a receiving connected object within the same or another network of connected objects.

Referring to FIG. 2, a diagram of the steps of a method implementation will now be described. The person skilled in the art will understand that the method can be executed continuously, and it can thus allow for the dynamic management of the routing parameters of a connection gateway. Such a dynamic method allows, for example, to adapt in real-time to the addition or removal of a new connection gateway in the network of connected objects. Additionally, such a dynamic method allows, for example, to generate and maintain a routing list used by a connection gateway to operate its data routing functions. Additionally, such a method also makes it possible to select, in real-time, the most appropriate transmission path for transmitting a message.

Furthermore, the method is executed by a connection gateway in a network of connected objects called local network of connected objects. The term local is used in contrast to the term remote, which refers to another network of connected objects to which the connection gateway performing the method steps does not belong, but which is nevertheless interconnected to the local network of connected objects through a data transport network. For example, in the unrestricted execution mode shown in FIG. 1, if the method is executed by the connection gateway 102 or 103, the local network of connected objects is the network 101 and the remote network of connected objects is the network 107. Conversely, if the method is executed by connection gateway 108, the local network of connected objects is network 107 and the remote network of connected objects is network 101.

The first step of the method consists, for a first connection gateway 103 of the local network of connected objects, in step 201 of generating a list of local connected objects that includes identification information elements associated with each connected object of the local network of connected objects that is connected to this connection gateway.

In particular, the identification information associated with a particular connected object may be, for example:

the type of communication interface supported by the connection gateway for connecting to the relevant connected object;

the name of the communication interface supported by the connection gateway for connecting to the relevant connected object;

the address of the relevant connected object on the communication interface supported by the connection gateway;

the unique universal identifier (UUID) of the relevant connected object; and,

a list of unique universal identifiers of other connected objects in the network of connected objects, with which the relevant connected object is suitable for connection, preferably configured to connect.

For example, referring to FIGS. 1 and 2, connected object 103a is adapted, preferably configured to connect to connected object 102a while connected object 103b is adapted, preferably configured to connect to connected object 108b.

In a way known to the person skilled in the art, a UUID is a unique identifier attributed to a connected object which is generated by the manufacturer of said connected object. The list of unique universal identifiers comprises, therefore, UUlDs of connected objects to which the connected object that responded to the broadcast request can access.

In a second step, the first connection gateway 103 of the local network of connected objects transmits 202 to at least one second connection gateway a list of unique identifiers of connected objects with which local connected objects 103a, 103b are likely to communicate. For example, this second connection gateway can be a local 102 or a remote 106 connection gateway. For example, this identifier list could include the unique identifier of connected object 108a to which connected object 103b is likely to connect. Preferably, the transmission is done by a broadcast type message.

Following the transmitted message, the first connection gateway may receive 203 one or more responses in the form of a routing message, for example a first routing message, from the second connection gateway(s). As shown in FIG. 2, the routing message contains a list of connected object identifiers with which local objects are likely to communicate and for which it has a transmission path (Rout_1). For example, referring to FIG. 1, the first connection gateway 103 can receive from connection gateway 102 a routing list containing the UUID of connected object 102a with transmission path data such as identification and accessibility information. In particular, this message may not comprise UUIDs of connected objects not directly connected to connection gateway 102 since the routing message should preferably be propagated between the connection gateways.

Thus, the first connection gateway may receive 204 one or more responses in the form of a second routing message from the second connection gateway(s). As shown in FIG. 2, the second routing messages comprise a list of connected object identifiers with which local objects are likely to communicate and for which the second connection gateway has a transmission path (Rout_1) or (Rout_2). For example, referring to FIG. 1, the first connection gateway 103 can receive from connection gateway 102 a routing list containing the UUID of connected object 108a with data on the transmission path (Rout_1) such as identification and accessibility information. The first connection gateway 103 can also receive from connection gateway 106 a routing list comprising the UUID of connected object 108a with data on the transmission path (Rout_2) such as identification and accessibility information.

Based on these routing messages, the first connecting gateway can generate 205 the routing list, which can also include identification and accessibility information respectively associated with each other connecting gateway in the local connected object network and with at least one other gateway in a remote connected object network which is accessible by this connecting gateway. Advantageously, such a routing list contains all the information useful to the connection gateway for carrying out its routing function and, in particular, for choosing among several possible transmission paths for transmitting data from a source connected object to a receiving connected object in the global network infrastructure. Additionally, the person skilled in the art will understand that, in practice, each connection gateway in a local network of connected objects can execute the method in parallel and thus keep the information useful for its routing functions updated.

Additionally, the identification and accessibility information associated with a given connection gateway, whether it belongs to the local network of connected objects or to a remote network of connected objects, may be, for example:

the type of communication interface supported by the connection gateway with this other connection gateway;

the name of the communication interface supported by the connection gateway with this other connection gateway;

the address of this other connection gateway on the communication interface supported by the connection gateway;

a list of UUIDs which includes:
the UUIDs of so-called remote connected objects which are able to be directly connected to the connection gateway concerned;
the UUIDs of other remote connected objects with which the connected objects directly connected with this connection gateway can have an established communication link; and,
the UUIDs, of other connection gateways connected to this connection gateway and which can transmit messages through it.

In one particular embodiment of the method, this list of UUIDs can be obtained by a concatenation of all of the data that it contains, i.e., of all the unique universal identifiers that are included in said list. Advantageously, such a concatenation allows to limit the quantity of data transmitted. Additionally, with regard to the UUIDs of the connection gateways which can transmit messages through the relevant connection gateway, these make it possible to form said mesh, i.e. to link several connection gateways which can then transfer a message from a connected object directly connected to a connection gateway to a connected object directly connected to another connection gateway.

The person skilled in the art will understand that the various information elements included in a routing list can be retrieved regularly by the connection gateway, for example, by means of messages addressed to it. Thus, in a non-limiting example, the connection gateway, prior to the execution of the method steps, has received messages from connected objects and/or local or remote connection gateways, which contain, respectively, identification information and identification and accessibility information. Additionally, such messages can be received by the connection gateway, for example, either following the broadcasting of a broadcast type request addressed to all the entities in the local connected objects network, or following the transmission of a request specifically addressed to a specific connection gateway, either local or remote, included in the global network infrastructure.

Furthermore, in a particular embodiment of the method, each connection gateway stores a routing list in a memory and updates this list upon receipt of a message which includes identification information or identification and accessibility information coming either from a connected object or from another connection gateway, respectively. For example, such an update takes place each time a message containing such information is received by the connection gateway. The dynamic aspect of the method then results from this regular updating. Thus, at each iteration of the method, a list stored in a memory of the connection gateway can integrate, in particular, new identifiers associated with new connected objects or new connection gateways that have transmitted them to it.

Furthermore, the method may include a subsequent step 206 that involves deleting redundant information elements from the routing list. The deletion of step 206 may be carried out based on a specific performance criterion and in such a way as to retain only a single copy of each piece of information included in the routing list. Typically, the same connected object can be identified several times in a routing list. In this case, in order to route a message whose recipient is this connected object, a connection gateway can select several transmission paths. The deletion step 206, thus makes it possible to keep only one transmission path per potential recipient. Additionally, the performance criterion makes it possible to retain, in the routing list, only the information associated with a transmission path considered to be the most appropriate path.

For example, the specific performance criterion may be based on a value associated with the latency of a data transmission (i.e. a message) from the connection gateway to a connected object or another connection gateway, or it may be based on a value associated with the distance separating the connection gateway from a connected object or another connection gateway. These performance criteria are non-limiting examples and it will be understood by the person skilled in the art that other criteria may be used, either alone or in combination, to maintain the routing list updated only with the most relevant information, i.e. information associated, for example, with the fastest or most stable transmission path.

Thus, in one embodiment of the method, the identification information associated with connected objects and the identification and accessibility information associated with connection gateways may include a value that represents the latency associated with a data transmission from the connection gateway to that particular connected object or connection gateway, respectively. Similarly, in another embodiment of the method, the identification information associated with connected objects and the identification and accessibility information associated with connection gateways may include a value that represents the distance between the connection gateway performing the method steps and said connected object or said connection gateway, respectively. Such a value may, for example, correspond to the number of connection gateways that separate the connection gateway from the relevant connected object or the relevant connection gateway. Additionally, for a connected object identified in a routing list, the distance associated with it may be equal to the distance from the connection gateway with which it is directly connected incremented by one unit.

The following step 207 is carried out every time the connection gateway receives a message to be transmitted from a source connected object to a receiving connected object, both of which belong to the network of connected objects. More particularly, this step 207 involves selecting a transmission path of the message to be transmitted based on the routing list generated and possibly modified by the connection gateway in the previous steps.

In other words, when the gateway recognizes the identifier of a connected object for which a message is intended, it can, thanks to its routing list in which this identifier is included, select the most suitable transmission path for transmitting the message in view of the performance criteria used. Additionally, in another embodiment of the method, said method also includes a step of sending the message to be transmitted. Specifically, a connected message issues a request to a specific connection gateway to send a message to another connected gateway for which it recognizes an identifier. This connection gateway then uses the selected transmission path to transmit said message.

Referring to FIG. 3, a functional drawing of an embodiment of a connection gateway and a connected object according to another aspect of this invention will now be described. The gateway is particularly suitable for carrying out the process described above. In the example shown, connection gateway 102 thus comprises a communication module 301, a generation module 302, a suppression module 303 and a selection module 304. Each module uses means which may be combinations of processors, random access memory, read-only memory, cache memory, as well as the (software) codes supporting instructions to operate these hardware elements.

The communication module 301 is advantageously configured to allow connection gateway 102 to transmit to a second connection gateway a list of unique identifiers of connected objects with which the local connected objects are likely to communicate, and to receive a first routing message from the second connection gateway, said routing message comprising a list of the identifiers of connected objects with which the local objects are likely to communicate and for which it has a transmission path.

The generation module 302 is advantageously configured to allow connection gateway 102 to generate a routing list that includes identification information associated with connected objects and identification and accessibility information associated with connection gateways.

The deletion module 303 is configured to delete identification information and/or redundant identification and accessibility information from the routing list so as to keep only a single copy of each of said information in the routing list. In particular, the deletion module 303 is configured to carry out this deletion based on a specific performance criterion. This criterion could be, for example, based on a parameter such as the latency associated with a transmission or the distance separating two entities within a network infrastructure.

Finally, the selection module 304 is configured to select a transmission path when connection gateway 102 receives a message to be transmitted from a source connected object to a receiving connected object both belonging to a network infrastructure formed by at least the network of connected objects to which the connection gateway belongs and at least one other network of connected objects to which it is interconnected through a data transport network.

Furthermore, the routing list can be stored by a memorization module 305. To do this, the memorization module can comprise any readable support known in the art comprising, for example, a volatile memory, such as a static random access memory (SRAM) and a dynamic random access memory (DRAM), and/or a non-volatile memory, such as a read-only memory, flash memories, hard disks, optical disks and magnetic bands, or in the form of a volatile memory, such as a random access memory (RAM) and/or a cache memory.

This invention has been described and illustrated in this detailed description and in the figures of the annexed drawings in possible embodiments. This invention is, however, not limited to the forms of embodiment presented. Other variants and embodiments can be deduced and implemented by the person skilled in the art when reading this description and seeing the attached drawings.

As previously described, this invention proposes solutions making possible optimized routing, in the sense that each connection gateway can intelligently select the transmission path that is most appropriate to transmit a message when several transmission paths are available. For this purpose, this invention enables a connection gateway included in a network infrastructure, formed by at least two networks of connected objects and a data transport network interconnecting them, to rely on a routing list established on the basis of a specific performance criteria to carry out the selection of the transmission path, even when the routing has to take place between connection gateways using different communication interfaces.

1. A method for dynamic routing in interconnected networks of connected objects, each network of connected objects comprising at least one connection gateway to at least one data transport network, said networks of connected objects being interconnected through said at least one data transport network, said method comprising the following steps, performed by a first connection gateway of a local network of connected objects:
transmitting, by the first connection gateway, to a second connection gateway, a list of unique connected object identifiers with which local connected objects are likely to communicate,
receiving, by the first connection gateway, a first routing message from the second connection gateway, said first routing message comprising a list of identifiers of the connected objects with which the local connected objects are likely to communicate and for which the second connection gateway has a transmission path,
generating a routing list including identification information respectively associated with the local connected objects connected to the first connection gateway and identification and accessibility information respectively associated with at least one second connection gateway of the local network of connected objects and/or in a remote network of connected objects accessible by said first connection gateway;
and, upon receipt by the first connection gateway of a message to be transmitted from a source connected object to a receiving connected object:
selecting a transmission path of the message to be transmitted based on the identification information and/or the identification and accessibility information included in the routing list.

2. The routing method according to claim 1, wherein the first gateway sends a concatenated list of the identifiers of the connected objects with which the local objects are likely to communicate, and the second gateway, either remote or local, returns a subset containing the identifiers for which it has a routing.

3. The routing method according to claim 1, further comprising a step of propagating the list of unique identifiers of connected objects with which the local connected objects are likely to communicate from gateway to gateway.

4. The routing method according to claim 1, wherein the first routing message coming from the second connection gateway comprises a list of the identifiers of connected objects directly connected to the second connection gateway, the method further comprising a step of reception by the first connection gateway of a second routing message coming from the second connection gateway, said second routing message comprising a list of the identifiers of connected objects with which the local objects are likely to communicate and for which it has a transmission path that implements another remote connection gateway.

5. The routing method according to claim 1, wherein the unique identifiers of connected objects are parameterized so as to be able to uniquely identify, in a subnetwork or subnetworks of the interconnected networks of connected objects, the connected objects linked through different communication protocols.

6. The routing method according to claim 1, wherein the first routing message comprises a list of unique universal identifiers, UUIDs, comprising UUIDs of local connected objects associated with:
UUIDs of remote connected objects directly connected to the second connection gateway;
UUIDs of remote connected objects that are connected to the second connection gateway through other connection gateways; or
UUIDs of remote connected objects with which the connected objects directly connected with the second connection gateway are able to establish a communication link.

7. The routing method according to claim 1, further comprising a step of deleting, based on a specific performance criterion, identification information and/or redundant identification and accessibility information from the routing list so as to maintain only a single copy of each of said information in the routing list.

8. The routing method according to claim 1, further comprising transmission by the first connection gateway of the message to be transmitted, to the receiving connected object, by the selected transmission path.

9. The method according to claim 1, wherein the identification and accessibility information associated with a second specific connection gateway in the local network of connected objects or in an accessible remote network of connected objects comprises one or more of the following information:
a type of communication interface supported by the first connection gateway for connection with said second connection gateway;
a name of the communication interface supported by the first connection gateway for connection with said second connection gateway;
an address of said connection gateway on the communication interface supported by the first connection gateway for connection with said second connection gateway;
a list of unique universal identifiers.

10. The method according to claim 9, wherein the list of unique universal identifiers is obtained by concatenating all the unique universal identifiers included in said list.

11. The method according to claim 1, wherein the connection gateways, each having its respective communication interface, and the communication interfaces used by the connection gateways comprise Ethernet interfaces, WIFI interfaces, Bluetooth interfaces, RF433 interfaces or IrDA interfaces.

12. The method according to claim 7, wherein the specific performance criterion is based on one or more of the following parameters:
latency associated with a data transmission from the first connection gateway to a connected object or to another connection gateway; and,
a distance separating the first connection gateway from a connected object or another connection gateway.

13. The method according to claim 1, wherein the identification information associated with a connected object and the identification and accessibility information associated with a connection gateway further comprise a value that represents a latency associated with a data transmission from the first connection gateway to said connected object or said connection gateway, respectively.

14. The method according to claim 1, wherein the identification information associated with a connected object and the identification and accessibility information associated with a connection gateway further comprise a value that represents a distance separating the first connection gateway from said connected object or from said connection gateway, respectively.

15. The method according to claim 1, wherein the routing list is stored in a memory of the first connection gateway and updated upon receipt, by the first connection gateway, of a message comprising identification information or identification and accessibility information from a connected object or another connection gateway, respectively.

16. A connection gateway of a network of connected objects, said network of connected objects being interconnected with another network of connected objects through at least one data transport network and comprising connection gateways, each having its respective communication interface, said connection gateway comprising:
a communication module configured to transmit to a second connection gateway a list of unique identifiers of connected objects with which local connected objects are likely to communicate, and to receive a first routing message from the second connection gateway, said routing message comprising a list of the identifiers of connected objects with which the local connected objects are likely to communicate and for which it has a transmission path;
a generation module configured to allow the connection gateway to generate a routing list that includes identification information associated with connected objects and identification and accessibility information associated with connection gateways;
a deletion module configured to delete identification information and/or redundant identification and accessibility information in the routing list so as to retain only a single copy of each of said information in the routing list; and,
a selection module configured to select a transmission path when the connection gateway receives a message to be transmitted from a source connected object to a receiving connected object of the network of connected objects, said selection being carried out based on the routing list.

17. A data communication system comprising at least two networks of connected objects interconnected through a data transport network, said networks of connected objects comprising a plurality of connection gateways, each having its respective communication interfaces, wherein each connection gateway is configured:
to transmit to a first connection gateway routing messages comprising a list of identifiers of the connected object with which the local connected objects of the first connection gateway are likely to communicate and for which it has a transmission path,
to generate a routing list that comprises identification information associated with connected objects and identification and accessibility information associated with connection gateways, and
to select, based on the routing list, a transmission path when the connection gateway receives a message to be transmitted from a source connected object to a receiving connected object of the network of connected objects.
